(19) United States
(12) Patent Application Publication
(10) Pub. No.: US 2007/0252012 A1
(43) Pub. Date: Nov. 1, 2007

(54) Digital Fluid Temperature Control Valve

(75) Inventors: Jeffrey T. Gardner, Woodland Park, CO (US); Oded Eddie Sturman, Woodland Park, CO (US); Timothy P. Kranz, Woodland Park, CO (US)

Correspondence Address: BLAKELY SOKOLOFF TAYLOR & ZAFMAN, 1279 OAKMEAD PARKWAY, SUNNYVALE, CA, 94085-4040, US

(73) Assignee: STURMAN DIGITAL SYSTEMS, LLC, Woodland Park, CO (US)

(21) Appl. No.: 11/734,396

(22) Filed: Apr. 12, 2007

Related U.S. Application Data
(60) Provisional application No. 60/791,334, filed on Apr. 12, 2006.

(51) Int. Cl. G05D 23/13

(52) U.S. Cl. 236/12.15; 236/12.1

(57) ABSTRACT

A device for controlling a temperature of a fluid includes a plurality of valve assemblies, each coupled to a cold fluid supply, a hot fluid supply, and an outlet line. An orifice is coupled to each outlet line and to a combined outlet line that is common to all orifices. Each of the orifices has a proportionally different flow area. Hot and cold fluid supply temperature sensing elements are coupled to supplies. A controller is coupled to the hot and cold fluid supply temperature sensing elements and the plurality of valve assemblies. The controller selectively couples one of the cold fluid supply or the hot fluid supply to the outlet line for each of the plurality of valve assemblies responsive to the cold fluid supply temperature sensing element, the hot fluid supply temperature sensing element, and a desired temperature in the combined outlet line.

### CROSS REFERENCE TO RELATED APPLICATIONS

This application claims priority pursuant to 35 U.S.C. §119(3) to U.S. Provisional Application No. 60/791,334, filed Apr. 12, 2006, which application is specifically incorporated herein.

### BACKGROUND

The purpose of the invention is to better control fluid temperature, specifically to do so in a digital fashion. The invention allows the control of an outlet fluid temperature based on digitally controlling the inlet flow of a cold supply and a hot supply of said fluid.

There are numerous analog methods of temperature control on the market. They typically use some form of proportional control derived from a mechanical element with inherent physical properties that react to temperature change. These devices use proportional control, throttling the flow of an inlet to a greater or lesser extent depending on the temperature's impact on the mechanical element.

These devices have limited to no ability of allowing the user to define the output temperature, the output temperature is physically defined. There are also practical limitations on the response time such devices are able to achieve.

### SUMMARY

A device for controlling a temperature of a fluid includes a plurality of valve assemblies, each coupled to a cold fluid supply, a hot fluid supply, and an outlet line. An orifice is coupled to each outlet line and to a combined outlet line that is common to all orifices. Each of the orifices has a proportionally different flow area. Hot and cold fluid supply temperature sensing elements are coupled to supplies. A controller is coupled to the hot and cold fluid supply temperature sensing elements and the plurality of valve assemblies. The controller selectively couples one of the cold fluid supply or the hot fluid supply to the outlet line for each of the plurality of valve assemblies responsive to the cold fluid supply temperature sensing element, the hot fluid supply temperature sensing element, and a desired temperature in the combined outlet line.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 is a schematic diagram of a device that embodies the invention with inlet and outlet connections to the device.

FIG. 2 is a schematic diagram of another device that embodies the invention with inlet and outlet connections to the device.

FIG. 3 is a block diagram showing a controller for the device.

### DETAILED DESCRIPTION

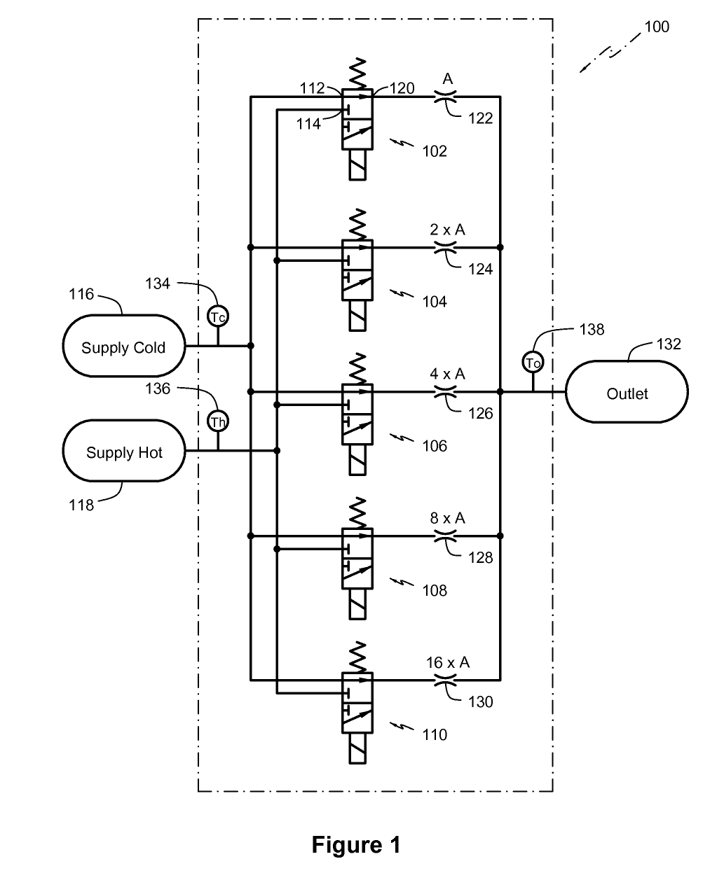

The present invention provides a device for controlling a temperature of a fluid. A device 100 that embodies the invention may be comprised of a number of significantly similar if not identical valves 102, 104, 106, 108, 110 plumbed in parallel, as shown in FIG. 1. These valves could be either 3-way valves or 2-way on-off valves. In the 3-way configuration, as shown in FIG. 1, the 2 inlets 112, 114 to the valves would be the cold supply 116 and the hot supply 118 of the fluid. The outlet of each valve 120 would be switched between the cold inlet or the hot inlet. The parallel valves would have orifice restrictions 122 placed at their outlets of proportionally different flow areas. For example, a five valve configuration could have areas of A 122, 2A 124, 4A 126, 8A 128, and 16A 130. This would allow for thirty-two different flow area combinations at the combined outlet line 132.

Temperature sensing elements 134, 136, 138 may be placed at the hot inlet and cold inlet lines, at the combined outlet line from the valves, or in all three lines to provide the information necessary to control the outlet temperature.

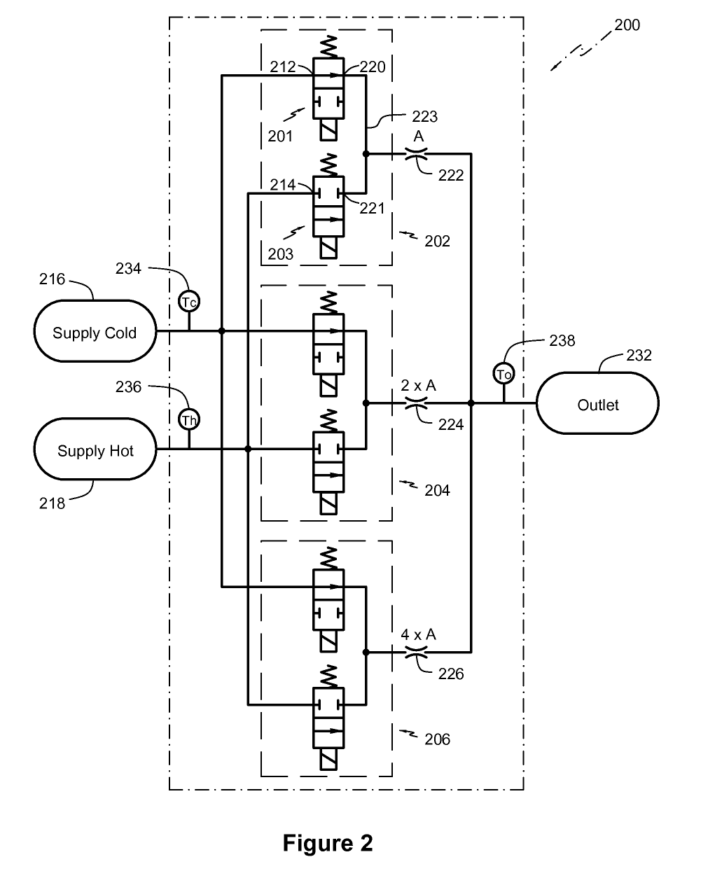

FIG. 2 shows an analogous 2-way valve configuration of the device 200 having three valve assemblies 202, 204, 206. Each valve assembly 202 includes a first on-off valve 201 attached to the cold fluid supply 216 and a second on-off valve 203 attached to the hot fluid supply 218. The outlets 220, 221 of the first and second on-off valves are attached to the same outlet line 223. The common outlet line 223 of each valve assembly is attached to an orifice 222.

The outlet orifice areas for each valve assembly would vary in a similar fashion to the 3-way configuration and the various hot and cold flow areas could be turned on and off to control the outlet temperature. The three pairs of valves would provide eight different flow area combinations. Preferably each of the orifices other than the smallest orifice 222 has a flow area that is substantially twice that of a next smaller orifice. For the device 200 of FIG. 2, the second orifice 224 may have twice the flow area of the first orifice 222. The third orifice 226 may have twice the flow area of the second orifice 224, and four times the flow area of the first orifice 222.

This invention allows for true digital control. A user could input the desired outlet temperature remotely and the valve would be able to actively control the outlet temperature to the user desired temperature, independent of shifts in the supply hot and cold temperatures. The digital control would also allow for very quick response to changes in the inlet temperatures as the control valves act in an on-off manner and are fast-acting (sub-second), mitigating the chances of sudden temperature shifts on the combined outlet line.

In some embodiments, the valve assemblies include magnetically latching valves. For example, in an embodiment using three-way valves 102 as shown in FIG. 1, the valve may be held in a first position by a spring. A single magnetic coil may be provided to actuate the valve. A valve controller may provide electrical pulses to latch or unlatch valves for the selective coupling of the cold or hot supplies to the orifice.

A current pulse may move the valve to a second position where it is held by residual magnetism. A degaussing pulse may be supplied to the coil to overcome the latching force and allow the spring to return the valve to the first position. In applications of the device where the valves remain in a fixed state for extended period of time, the use of magnetically latching valves may substantially reduce the energy consumption of the device.

The first position where the valve is held by spring force may couple the cold supply to the orifice. A backup source of power such as a capacitor may be provided to allow the valves to be unlatched in the event of a loss of the main power supply. In some embodiments a rechargeable battery may provide backup power. The low power requirement of latching valves may permit the device to run for extended periods of time from the battery, such as common nine volt battery. Using inlet temperature measurements for feed forward control may minimize the number of valve switches necessary to produce a temperature change and further reduce the power required by the device.

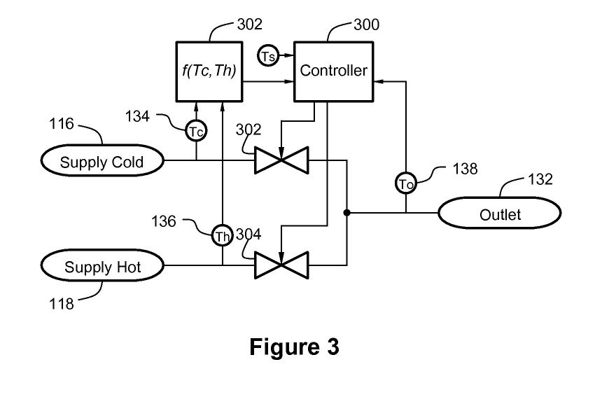

FIG. 3 is a block diagram of the device showing an embodiment of a controller 300 for the device. The controller may include a temperature prediction module 302 to predict a temperature in the combined outlet line 132 using inputs from the cold fluid supply temperature sensing element 134 and the hot fluid supply temperature sensing element 136, and a state of the plurality of. The controller 300 may selectively couple the valve assemblies 302, 304 to the outlet 132 responsive to a difference between the desired temperature, Ts, and the predicted temperature as determined by the temperature prediction module 302.

The temperature prediction module 302 may further use a predetermined fluid volume of the device between the cold fluid supply temperature sensing element, the hot fluid supply temperature sensing element, and the combined outlet line to determine a time for the selective coupling. This may compensate for the time lag between sensing the inlet temperatures and the arrival of the sensed fluid at the valve assemblies 302, 304. The time compensation may further use the state of the valve assemblies 302, 304 to estimate the flow rates within the two supplies 116, 118. It will be appreciated that the flow rates within the two supplies will generally be different. Therefore, even if both supplies change at the same time, the temperature prediction module 302 may provide different times at which the controller 300 should adjust the valves 302, 304 for the two changes.

The device may further include an output temperature sensing element 138 coupled to the combined outlet line 132 and the controller 300. The controller may further adjust the settings of the valves 302, 304 responsive to an actual temperature in the combined outlet line. The controller 300 may suppress adjustments based on the actual temperature in the combined outlet line for a period of time after adjustments made in response to the predicted temperature to allow the effects of the prior adjustments to be reflected in the output of the output temperature sensing element 138.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A device for controlling a temperature of a fluid comprising:
a plurality of valve assemblies, each valve assembly coupled to a cold fluid supply, a hot fluid supply, and an outlet line;
a like plurality of orifices, each orifice having an inlet coupled to the outlet line of one of the plurality of valve assemblies and an outlet coupled to a combined outlet line that is common to all of the plurality of orifices, each of the plurality of orifices having a proportionally different flow area;
a cold fluid supply temperature sensing element coupled to the cold fluid supply;
a hot fluid supply temperature sensing element coupled to the hot fluid supply; and
means for controlling the outlet temperature coupled to the cold fluid supply temperature sensing element, the hot fluid supply temperature sensing element, and the plurality of valve assemblies, the outlet temperature being controlled by selectively coupling one of the cold fluid supply or the hot fluid supply to the outlet line for each of the plurality of valve assemblies responsive to a desired temperature in the combined outlet line, the cold fluid supply temperature sensing element, and the hot fluid supply temperature sensing element.

2. The device of claim 1 wherein each of the plurality of valve assemblies includes a first on-off valve attached to the cold fluid supply and a second on-off valve attached to the hot fluid supply, the outlets of the first and second on-off valves being attached to the outlet line.

3. The device of claim 1 wherein each of the plurality of orifices other than a smallest orifice has a flow area that is substantially twice that of a next smaller orifice.

4. The device of claim 1 wherein each of the plurality of valve assemblies includes a magnetically latching valve and the means for controlling the outlet temperature provides electrical pulses to latch or unlatch valves.

5. The device of claim 1 wherein the means for controlling the outlet temperature includes means for predicting a temperature in the combined outlet line using inputs from the cold fluid supply temperature sensing element and the hot fluid supply temperature sensing element, and a state of the plurality of valve assemblies, the selective coupling being responsive to a difference between the desired temperature and the predicted temperature.

6. The device of claim 5 wherein the means for predicting a temperature in the combined outlet line further uses a predetermined fluid volume of the device between the cold fluid supply temperature sensing element, the hot fluid supply temperature sensing element, and the combined outlet line to determine a time for the selective coupling.

7. The device of claim 1 further comprising an output temperature sensing element coupled to the combined outlet line and the means for controlling the outlet temperature, the selective coupling being responsive to the output temperature sensing element.

8. A device for controlling a temperature of a fluid comprising:
a plurality of valve assemblies, each valve assembly coupled to a cold fluid supply, a hot fluid supply, and an outlet line;
a like plurality of orifices, each orifice having an inlet coupled to the outlet line of one of the plurality of valve assemblies and an outlet coupled to a combined outlet line that is common to all of the plurality of orifices, each of the plurality of orifices having a proportionally different flow area;
a cold fluid supply temperature sensing element coupled to the cold fluid supply;
a hot fluid supply temperature sensing element coupled to the hot fluid supply; and
a controller coupled to the cold fluid supply temperature sensing element, the hot fluid supply temperature sensing element, and the plurality of valve assemblies, the controller selectively coupling one of the cold fluid supply or the hot fluid supply to the outlet line for each of the plurality of valve assemblies responsive to a desired temperature in the combined outlet line, the cold fluid supply temperature sensing element, and the hot fluid supply temperature sensing element.

9. The device of claim 8 wherein each of the plurality of valve assemblies includes a first on-off valve attached to the cold fluid supply and a second on-off valve attached to the hot fluid supply, the outlets of the first and second on-off valves being attached to the outlet line.

10. The device of claim 8 wherein each of the plurality of orifices other than a smallest orifice has a flow area that is substantially twice that of a next smaller orifice.

11. The device of claim 8 wherein each of the plurality of valve assemblies includes a magnetically latching valve and the controller provides electrical pulses to latch or unlatch valves for the selective coupling.

12. The device of claim 8 wherein the controller includes a temperature prediction module to predict a temperature in the combined outlet line using inputs from the cold fluid supply temperature sensing element and the hot fluid supply temperature sensing element, and a state of the plurality of valve assemblies, the selective coupling being responsive to a difference between the desired temperature and the predicted temperature.

13. The device of claim 12 wherein the temperature prediction module further uses a predetermined fluid volume of the device between the cold fluid supply temperature sensing element, the hot fluid supply temperature sensing element, and the combined outlet line to determine a time for the selective coupling.

14. The device of claim 8 further comprising a output temperature sensing element coupled to the combined outlet line and the controller, the selective coupling being further responsive to an actual temperature in the combined outlet line.

15. A device for controlling a temperature of a fluid comprising:
a plurality of valve assemblies, each valve assembly coupled to a cold fluid supply, a hot fluid supply, and an outlet line, each of the plurality of valve assemblies includes a magnetically latching valve;
a like plurality of orifices, each orifice having an inlet coupled to the outlet line of one of the plurality of valve assemblies and an outlet coupled to a combined outlet line that is common to all of the plurality of orifices, each of the plurality of orifices having a proportionally different flow area;
a controller coupled to the plurality of valve assemblies, the controller providing electrical pulses to latch or unlatch valves and thereby selectively couple one of the cold fluid supply or the hot fluid supply to the outlet line for each of the plurality of valve assemblies to provide a desired temperature in the combined outlet line.

16. The device of claim 15 wherein each of the plurality of valve assemblies includes a first on-off valve attached to the cold fluid supply and a second on-off valve attached to the hot fluid supply, the outlets of the first and second on-off valves being attached to the outlet line.

17. The device of claim 15 wherein each of the plurality of orifices other than a smallest orifice has a flow area that is substantially twice that of a next smaller orifice.

18. The device of claim 15 further comprising a cold fluid supply temperature sensing element coupled to the cold fluid supply and to the controller, a hot fluid supply temperature sensing element coupled to the hot fluid supply and to the controller, the selective coupling being responsive to a temperature of the cold fluid supply and the hot fluid supply.

19. The device of claim 18 wherein the controller includes a temperature prediction module to predict a temperature in the combined outlet line using inputs from the cold fluid supply temperature sensing element and the hot fluid supply temperature sensing element, and a state of the plurality of valve assemblies, the selective coupling being responsive to a difference between the desired temperature and the predicted temperature.

20. The device of claim 19 wherein the temperature prediction module further uses a predetermined fluid volume of the device between the cold fluid supply temperature sensing element, the hot fluid supply temperature sensing element, and the combined outlet line.

21. The device of claim 18 further comprising a output temperature sensing element coupled to the combined outlet line and the controller, the selective coupling being further responsive to a temperature in the combined outlet line.
